(19) United States
(12) Patent Application Publication
(10) Pub. No.: US 2010/0189908 A1
(43) Pub. Date: Jul. 29, 2010

(54) FORMULATION METHOD FOR PLURAL COMPONENT LATEX- FOAM

(76) Inventors: Fatemeh N. Olang, Granville, OH (US); Robert J. O'Leary, Newark, OH (US); Michelle Korwin-Edson, Pataskala, OH (US); Robert E. Quinn, New Albany, OH (US)

Correspondence Address: OWENS CORNING, 2790 COLUMBUS ROAD, GRANVILLE, OH, 43023, US

(21) Appl. No.: 12/688,951

(22) Filed: Jan. 18, 2010

Related U.S. Application Data
(63) Continuation-in-part of application No. 11/893,451, filed on Aug. 16, 2007.
Application No. 11/893,451 is a continuation-in-part of application No. 11/893,474, filed on Aug. 16, 2007.
Application No. 11/893,474 is a continuation-in-part of application No. 11/893,435, filed on Aug. 16, 2007.
Application No. 11/893,435 is a continuation-in-part of application No. 11/893,436, filed on Aug. 16, 2007.
Application No. 11/893,436 is a continuation-in-part of application No. 11/647,747, filed on Dec. 29, 2006.
(60) Provisional application No. 61/182,345, filed on May 29, 2009.
(60) Provisional application No. 61/145,740, filed on Jan. 19, 2009.

(51) Int. Cl. C08J 9/00; B05D 1/02

(52) U.S. Cl. 427/427.4; 521/90

(57) ABSTRACT

Latex spray foams formed from a two-part foamable composition are provided. The A-side contains a functionalized latex and an acid and the B-side contains a polyfunctional aziridine crosslinking agent, a plasticizer, a base, and, optionally, a non-functionalized resin. The acid and the base form a blowing agent package that when mixed, react to form a gas. The A- and B-side also contain thickening agents. The polyfunctional aziridine crosslinking agent is diluted by a plasticizer, which reduces the viscosity of the B-side and reduces the amount of ethyleneimine, a toxic component in the polyfunctional aziridine crosslinking agent. The presence of a plasticizer also permits the inclusion of other materials that may add functionality and/or cost savings to the foamed product. The plasticizer should have no acidic protons to react with the crosslinking agent. When no acidic protons are present, the B-side is stable for extended periods of time.

### CROSS-REFERENCE TO RELATED APPLICATIONS

This application is a continuation-in-part of U.S. patent application Ser. Nos. 11/893,451; 11/893,474; 11/893,435; and 11/893,436, each of which are entitled “Room Temperature Crosslinked Foam” and were filed on Aug. 16, 2007, which are continuation-in-parts of U.S. patent application Ser. No. 11/647,747, entitled “Spray-In Latex Foam For Sealing And Insulating” filed on Dec. 29, 2006, the entire contents of which are expressly incorporated herein by reference in their entireties.

### TECHNICAL FIELD AND INDUSTRIAL APPLICABILITY OF THE INVENTION

The present invention relates generally to foams and, more particularly, to two-part spray foams formed from foamable composition that has an A-side containing a latex and a B-side that contains a polyfunctional aziridine crosslinking agent and a plasticizer. The foams are used to fill cavities, cracks, and crevasses to enhance the sealing and insulating properties of buildings, cars, and appliances and to form backing for carpets, cushions, mattresses, pillows, and toys. A method of making such foams is also provided.

### BACKGROUND OF THE INVENTION

Spray foams have found widespread utility in the fields of insulation and structural reinforcement. For example, spray foams are commonly used to insulate or impart structural strength to items such as automobiles, hot tubs, refrigerators, boats, and building structures. In addition, spray foams are used in applications such as cushioning for furniture and bedding, padding for underlying carpets, acoustic materials, textile laminates, and energy absorbing materials. Currently, spray foams, especially those used as insulators or sealants for home walls, are polyurethane spray foams.

Polyurethane spray foams and their methods of manufacture are well known. Typically, polyurethane spray foams are formed from two separate components, commonly referred to as an “A” side and a “B” side, that react when they come into contact with each other. The first component, or the “A” side, contains an isocyanate such as a di- or poly-isocyanate that has a high percent of NCO (nitrogen, carbon, and oxygen) functional groups on the molecule. The second component, or “B” side, contains nucleophilic reagents such as polyols that include two or more hydroxyl groups, silicone-based surfactants, blowing agents, catalysts, and/or other auxiliary agents. The nucleophilic reagents are generally polyols, primary and secondary polyamines, and/or water. Preferably, mixtures of diols and triols are used to achieve the desired foaming properties. The overall polyol hydroxyl number is designed to achieve a 1:1 ratio of first component to second component (A:B).

The two components are typically delivered through separate lines into a spray gun such as an impingement-type spray gun. The first and second components are pumped through small orifices at high pressure to form separate streams of the individual components. The streams of the first and second components intersect and mix with each other within the gun and begin to react. The heat of the reaction causes the temperature of the reactants in the first and second components to increase. This rise in temperature causes the blowing agent located in the second component (the “B” side) to vaporize and form a foam mixture. As the mixture leaves the gun, the mixture contacts a surface, sticks to it, and continues to react until the isocyanate groups have completely reacted. The resulting resistance to heat transfer, or R-value, may be from 3.5 to 8 per inch.

There are several problems associated with conventional polyurethane spray foams. For example, although sealing a building with such polyurethane spray foams reduces drafts and keeps conditioned air inside and external air outside of a building, there is a reduction in the ability of moisture to penetrate the building. As a result, the levels of moisture and air pollutants rise in these tightly sealed buildings that no longer permit moisture penetration into the building.

Another problem associated with conventional polyurethane spray foams is that the first component (the “A” side) contains high levels of methylene-diphenyl-diisocyanate (MDI) monomers. When the foam reactants are sprayed, the MDI monomers form droplets that may be inhaled by workers installing the foam if stringent safety precautions are not followed. Even a brief exposure to isocyanate monomers may cause difficulty in breathing, skin irritation, blistering and/or irritation to the nose, throat, and lungs. Extended exposure of these monomers can lead to a sensitization of the airways, which may result in an asthmatic-like reaction and possibly death.

An additional problem with such conventional polyurethane spray foams is that residual polymeric methylene-diphenyl-di-isocyanate (PMDI) that is not used is considered to be a hazardous waste. PMDI typically has an NCO of about 20%. In addition, PMDI can remain in a liquid state in the environment for years. Therefore, specific procedures must be followed to ensure that the PMDI waste product is properly and safely disposed of in a licensed land fill. Such precautions are both costly and time consuming.

Attempts have been made to reduce or eliminate the presence of isocyanate and/or isocyanate emission by spray foams into the atmosphere. Non-limiting examples of such attempts are set forth below.

U.S. Patent Publication No. 2006/0047010 to O′Leary teaches a spray polyurethane foam that is formed by reacting an isocyanate prepolymer composition with an isocyanate reactive composition that is encapsulated in a long-chain, inert polymer composition. The isocyanate prepolymer composition contains less than about 1 wt % free isocyanate monomers, a blowing agent, and a surfactant. The isocyanate reactive composition contains a polyol or a mixture of polyols that will react with the isocyanate groups and a catalyst. During application, the spray gun heats the polymer matrix, which releases the polyols and catalyst from the encapsulating material. The polyols subsequently react with the isocyanate prepolymer to form a polyurethane foam.

U.S. Pat. No. 7,053,131 to Ko, et al. discloses absorbent articles that include super critical fluid treated foams. In particular, super critical carbon dioxide is used to generate foams that assertedly have improved physical and interfacial properties.

U.S. Pat. No. 6,753,355 to Stollmaier, et al. discloses a composition for preparing a latex foam that includes a latex and a polynitrilic oxide (e.g., 2,4,6-triethylbenzene-1,3-dinitrile oxide) or a latex and an epoxy silane. The latex may be carboxylated. It is asserted that the composition is stable for at least twelve months and that the one-part coating systems can be cured at room temperature without the release of by-products.

U.S. Pat. No. 6,414,044 to Taylor teaches foamed caulk and sealant compositions that include a latex emulsion and a liquid gaseous propellant component. The foamed compositions do not contain a gaseous coagulating component.

U.S. Pat. No. 6,071,580 to Bland, et al. discloses an absorbent, extruded thermoplastic foam made with blowing agents that include carbon dioxide. The foam is allegedly capable of absorbing liquid at about 50 percent or more of its theoretical volume capacity.

U.S. Pat. No. 5,741,823 to Hsu teaches producing a smooth, hard coating on a wood substrate. The coating is made of a foamed, polymerized latex emulsion and is applied on the surface of a wood substrate.

U.S. Pat. No. 5,585,412 to Natoli, et al. discloses a process for preparing flexible CFC-free polyurethane foams that uses an encapsulated blowing agent. The process provides a polyurethane foam having a desired density that avoids the use of chlorofluorocarbons or other volatile organic blowing agents. The encapsulated blowing agent assertedly supplements the primary blowing action provided by water in the manufacture of water-blown polyurethane foam and facilitates in the production of foam having the desired density.

U.S. Pat. No. 4,306,548 to Cogliano discloses lightweight foamed porous casts. To manufacture the casts, expanded non-porous polystyrene foam beads or other shapes are coated with a layer of neoprene, natural rubber, or other latex. The coated polystyrene is then encased in a porous envelope, and the envelope is applied to a broken limb. Additional coated polystyrene is added over the envelope and a gaseous coagulant is added to gel the latex, which causes the polystyrene beads to adhere to each other and produce a unified, rigid structure.

Latex foams have also been used to reduce or eliminate the presence of isocyanate and/or isocyanate emission by spray foams. Typical plural component latexes are supplied with a latex as the major component in the “A” side and a crosslinking agent as the minor component in the “B” side. The crosslinking agent in the latex spray foams is generally highly reactive. Thus, the crosslinking agent is generally supplied neat (i.e., not in solution). Additionally, the high reactivity of the crosslinking agent may reduce the stability and result in a short shelf life of the foamable material.

Despite these attempts to reduce or eliminate the use of isocyanate in spray foams and/or reduce isocyanate emission into the air, there remains a need in the art for a spray foam that is non-toxic, environmentally friendly, and stable over time.

### SUMMARY OF THE INVENTION

It is an object of the present invention to provide a two-part foamable composition for forming a foam that includes (1) a first component including at least one functionalized resin selected from a functionalized water-dispersible resin and a functionalized water-soluble resin and an acid and (2) a second component including a polyfunctional aziridine crosslinking agent that crosslinks at or about room temperature, a plasticizer that has no acidic protons to react with the polyfunctional aziridine crosslinking agent, and a base. The second component may further include a non-functionalized resin that is non-reactive with the polyfunctional aziridine crosslinking agent. The plasticizer may be selected from a benzoate ester, triethyl citrate, a tributyl citrate, polyethylene glycol, an octylphenoxypolyethoxyethanol, butyl benzoate, and combinations thereof. In at least one exemplary embodiment, the plasticizer is a benzoate ester and the benzoate ester reduces the presence of ethyleneimine in the second component to less than about 0.03 μg/g. The presence of the plasticizer permits for the inclusion of coacervating agents, fillers, nucleating agents and/or foaming agents in the second component. In addition, the plasticizer reduces the viscosity of the second component such that the second component can be mixed with the first component to form an homogenous mixture. In exemplary embodiments, the functionalized resin is one or more members selected from a functionalized latex and an acrylic solution.

It is also an object of the present invention to provide a foamed product comprising the reaction product of (1) a first component including at least one functionalized resin selected from a functionalized water-dispersible resin and a functionalized water-soluble resin and an acid and (2) a second component including a polyfunctional aziridine crosslinking agent that crosslinks at or about room temperature, a plasticizer, and a base. The second component may further include a non-functionalized resin that is non-reactive with the polyfunctional aziridine crosslinking agent. In addition, at least one of the first component and second component further includes an alcohol co-solvent. In exemplary embodiments, the functionalized resin is one or more members selected from a functionalized latex and an acrylic solution. The plasticizer has no acidic protons to react with said polyfunctional aziridine crosslinking agent. Additionally, the plasticizer may be selected from a benzoate ester, triethyl citrate, a tributyl citrate, polyethylene glycol, an octylphenoxypolyethoxyethanol, butyl benzoate, and combinations thereof. The presence of the plasticizer permits for the inclusion of coacervating agents, fillers, nucleating agents and/or foaming agents in the second component. In at least one exemplary embodiment, the plasticizer is a benzoate ester and the benzoate ester reduces the presence of ethyleneimine in the second component to less than about 0.03 μg/g.

It is yet another object of the present invention to provide method of forming a foam barrier that includes (1) delivering a first component including one or more functionalized resins selected from a functionalized water-dispersible resin and a functionalized water-soluble resin through a first delivery line to an application device, (2) delivering a second component including a polyfunctional aziridine crosslinking agent that crosslinks at or about room temperature, a plasticizer, and a base, to the application device, where the plasticizer has no acidic protons to react with the polyfunctional aziridine crosslinking agent, (3) mixing the first and second components within the application device to form a reaction mixture, (4) permitting the polyfunctional aziridine crosslinking agent, the acid, and the one or more functionalized resins to chemically react while the acid and the base react to form a gas to initiate a foaming reaction and form a foam, and (5) spraying the foam to a desired location. The desired location may be selected from an open cavity, a closed cavity, a crevasse and a crack. The method may also include a diluting step where ethyleneimine contained within the polyfunctional aziridine crosslinking agent reacts with acid impurities and water in the second component to reduce the level of the ethyleneimine in the second component to less than about 0.03 μg/g. The second component may further include a non-functionalized resin that is non-reactive with the polyfunctional aziridine crosslinking agent. In addition, at least one of the first component and second component further includes an alcohol co-solvent. The plasticizer is selected from a benzoate ester, triethyl citrate, a tributyl citrate, polyethylene glycol, an octylphenoxypolyethoxyethanol, butyl benzoate, and combinations thereof. Additionally, the presence of the plasticizer permits for the inclusion of coacervating agents, fillers, nucleating agents and/or foaming agents in the second component.

It is an advantage of the present invention that the inventive foams do not contain the harmful chemicals found in conventional polyurethane spray foams, such as, for example, MDI monomers. As a result, the foams of the present invention do not contain harmful vapors that may cause skin or lung sensitization or generate toxic waste.

It is also an advantage of the present invention that the spray foams do not emit harmful vapors into the air when the foam is sprayed, such as when filling cavities to seal and/or insulate a building. The inventive foams are safe for workers to install and, therefore, can be used both in the house renovation market and in occupied houses.

It is another advantage of the present invention that the foams may be applied using existing spray equipment designed for conventional two-part spray polyurethane foam systems without clogging the spray equipment. Thus, the application gun is capable of repeated use without clogging and the resulting necessary cleaning when the foams of the present invention are utilized.

It is yet another advantage of the present invention that diluting the polyfunctional aziridine crosslinking agent with a plasticizer permits the toxic components within the polyfunctional aziridine to be diluted and/or reacted, thereby reducing health risks to those individuals in contact with the foamable composition.

It is also an advantage of the present invention that the components of the B-side of the foam compositions may be stored for extended periods of time without significant reaction until the composition is used when the polyfunctional aziridine crosslinking agent is diluted and the B-side components do not contain any acidic protons.

It is yet another advantage of the present invention that the polyfunctional aziridine crosslinking agent reacts with the acid in the A-side to create a polymeric structure of skeleton that supports the foam while the latex is coagulating.

It is another advantage of the present invention that diluting the polyfunctional aziridine crosslinking agent significantly reduces the presence of ethyleneimine and propyleneimine, toxic components in the polyfunctional aziridine.

It is a feature of the present invention that coacervating agents, fillers, nucleating agents, and/or foaming agents can be added to the B-side when the polyfunctional aziridine crosslinking agent is diluted.

It is a further feature of the present invention that the viscosity of the B-side can be reduced by diluting the polyfunctional crosslinking agent with a plasticizer so that the B-side can be easily pumped through a spray gun.

It is also a feature of the present invention that impurities in the benzoate ester, such as benzoic acid, neutralize the ethyleneimine in the polyfunctional aziridine crosslinking agent.

It is yet another feature of the present invention that the foam acts as a first defence for pest control.

It is a further feature of the present invention that the foam is resistant to cracking at different application temperatures.

It is also a feature of the present invention that the foam compositions may be used to fill open or closed cavities or to fill cracks and crevasses.

The foregoing and other objects, features, and advantages of the invention will appear more fully hereinafter from a consideration of the detailed description that follows.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references. The terms “foamable composition” and “foam composition” may be interchangeably used in this application.

The present invention relates to two-part foamable compositions having an A-side and a B-side. The A-side of the foam composition includes a functionalized water-dispersible and/or a functionalized water-soluble resin (e.g., a functionalized latex or a functionalized latex and an acrylic solution) and an acid and the B-side contains a polyfunctional aziridine crosslinking agent, a plasticizer, a base, and optionally, a non-reactive resin. The acid and the base together form a blowing agent package that generates a gas. The B-side may also contain coacervating agents, fillers, nucleating agents, and/or foaming agents. The inventive foams may be used to fill cavities of buildings to improve the sealing and insulation properties and to seal cracks and crevasses, such as those around windows and doors. Additionally, the foams may be used to form items such as cushions, carpet backing, mattresses, pillows, and toys. The inventive foams can be used in spray, molding, extrusion, and injection molding applications. Further, unlike conventional spray polyurethane foams, the foams of the present invention do not contain isocyanate. Therefore, no MDI monomers are present in the inventive foams and no harmful chemicals are emitted during installation of the foams.

As discussed above, the A-side of the composition for the foams includes a functionalized water-dispersible and/or a functionalized water-soluble resin. The functionalized water-dispersible resin may be a functionalized latex, and in exemplary embodiments, the latex system is an acrylic emulsion. Non-limiting examples of suitable water-soluble resins for use in the inventive compositions include acrylic solutions and polyols. In addition to the functionalized water-dispersible and/or functionalized water-soluble resin, the serum can contain a polyacrylic oligomer to increase the total number of the functional groups. It is to be appreciated that although any functionalized water-soluble and/or functionalized water-dispersible resin(s) may be used as a component in the foamable compositions described herein, reference will be made to functionalized latexes with or without an acrylic solution.

There are numerous types of latexes that may be used as the functionalized water-dispersible component in the aqueous resin solution of the present invention. Non-limiting examples of suitable latexes include natural and synthetic rubber resins, and mixtures thereof, including thermosettable rubbers; thermoplastic rubbers and elastomers including, for example, nitrile rubbers (e.g., acrylonitrile-butadiene); polyisoprene rubbers; polychloroprene rubbers; polybutadiene rubbers; butyl rubbers; ethylene-propylene-diene monomer rubbers (EPDM); polypropylene-EPDM elastomers; ethylene-propylene rubbers; styrene-butadiene copolymers; styrene-isoprene copolymers; styrene-butadiene-styrene rubbers; styrene-isoprene-styrene rubbers; styrene-ethylene-butylene-styrene rubbers; styrene-ethylene-propylene-styrene rubbers; polyisobutylene rubbers; ethylene vinyl acetate rubbers; silicone rubbers including, for example, polysiloxanes; methacrylate rubbers; polyacrylate rubbers including, for example, copolymers of isooctyl acrylate and acrylic acid; polyesters; polyether esters; polyvinyl chloride; polyvinylidene chloride; polyvinyl ethers; polyurethanes and blends; and combinations thereof, including, for example, linear, radial, star, and tapered block copolymers thereof. In exemplary embodiments, the latex for use in the inventive foam composition is a carboxylated acrylic latex.

The water-dispersible and water-soluble resin may be functionalized. The functional group may be any functional group capable of crosslinking, including carboxylic acid, hydroxyl, methylol amide groups, and sulfonates. In at least one exemplary embodiment, the water-dispersible and/or water-soluble resin(s) contains from about 1.0 to about 20 wt % functional groups based on the total wet weight of the resin, or from about 2.0 to about 15.0 wt % functional groups based on the total dry weight of the resin. The functionality of the functionalized water-dispersible and/or water-soluble resin can be adjusted by adding or removing functional groups to or from the resin backbone to reach the optimum amount of crosslinking and ultimately the optimum strength and modulus of the foam.

Additionally, the A-side contains at least one acid. The acid is placed in the A-side to avoid the inclusion of the acidic protons in the acid in the B-side and an undesirable pre-reaction of the polyfunctional aziridine crosslinking agent. The acid may have a solubility of 0.5 g/100 g of water or greater at 30° C. In exemplary embodiments, the acid is a dry acid powder with or without chemically bound water. Non-exclusive examples of suitable acids include citric acid, oxalic acid, tartaric acid, succinic acid, fumaric acid, adipic acid, maleic acid, malonic acid, glutaric acid, phthalic acid, metaphosphoric acid, or salts that are convertible into an acid that is an alkali metal salt of citric acid, tartaric acid, succinic acid, fumaric acid, adipic acid, maleic acid, oxalic acid, malonic acid, glutaric acid, phthalic acid, metaphosphoric acid, or a mixture thereof. Examples of salts which are convertible into acids include, but are not limited to, aluminum sulfate, calcium phosphate, alum, a double salt of an alum, potassium aluminum sulfate, sodium dihydrogen phosphate, potassium citrate, sodium maleate, potassium tartrate, sodium fumarate, sulfonates, and phosphates. In exemplary embodiments, the acid is a polymeric acid. The acid(s) may be present in an amount from about 1.0 to about 30 percent by weight of the dry foam composition, and in exemplary embodiments, in an amount from about 3.0 to about 20 percent by weight.

The B-side of the foam composition, as indicated previously, contains a polyfunctional aziridine crosslinking agent, a plasticizer, a base, and optionally, a non-reactive resin. In particular, the non-reactive resin is a resin that does not react with the polyfunctional aziridine crosslinking agent, but is otherwise non-limiting. Examples of suitable polyfunctional amines include XAMA®-7 and XAMA®-2, tri-functional aziridines available from Bayer Corporation; Crosslinker CX-100, a polyfunctional aziridine available from DSM NeoResins; and XC-103, a trifunctional aziridine available from Zealchem. The polyfunctional aziridine crosslinking agent may be present in the B-side in an amount from about 3.0 to about 30 percent by weight of the dry foam composition, preferably in an amount from about 1.0 to about 20 percent by weight. Although a mole ratio of the resin functional groups to the polyfunctional aziridine crosslinking agent functional groups of 1:1 is preferred, this molar ratio is variable and may encompass a wider range, such as, for example, from 0.5:1 to 2:1 to provide the optimum crosslinking in the final foam products.

According to one aspect of the invention, the crosslinking agent is diluted by a plasticizer. The plasticizer should have no acidic protons to react with the aziridine groups in the crosslinking agent. Examples of suitable plasticizers for use in the B-side of the foamable composition include butyl benzoate, Benzoflex® 2088 (a benzoate ester plasticizer available from Genovique Specialties), Benzoflex® LA-705 (a benzoate ester plasticizer available from Genovique Specialties), Triton® X-100 (an octylphenoxypolyethoxyethanol available from Cognis), PEG-400 (a polyethylene glycol available from Cognis), Citroflex® 2 (a triethyl citrate available from Vertellus® Specialties), and Citroflex° 4 (a tributyl citrate available from Vertellus® Specialties). In exemplary embodiments, the plasticizer is a benzoate ester or a citric acid ester.

Diluting the polyfunctional aziridine crosslinking agent provides several advantages. For example, the toxic components of the polyfunctional aziridine can be diluted with a small amount of benzoic acid in the benzoate ester to reduce health risks to those in contact with the polyfunctional aziridine. Polyfunctional aziridine contains about 0.001% of ethyleneimine, which is very reactive moiety, and in theory, will react with the very small level of acid impurities or water content of the other components the B-side. In addition, the viscosity of the B-side is reduced when the crosslinking agent is diluted with the plasticizer. As a result, the components of the B-side can be better mixed with the latex of the A-side in the spray gun to form an homogeneous mixture. Also, the plasticizer allows the foam composition to be delivered with standard plural component spray equipment, thereby negating the need for any specialized equipment.

Additionally, the presence of the plasticizer permits for the inclusion of other solid materials that may add functionality and/or cost savings to the final foamed product. For instance, coacervating agents, fillers (e.g., calcium carbonate and wollastonite fibers), nucleating agents (e.g., talc), and/or foaming agents (e.g., sodium bicarbonate) can be included in the B-side of the foamable composition. It is to be appreciated that when the plasticizer and other components in the B-side do not contain any acidic protons, the B-side is stable for extended periods of time, such as up to at least six months or more.

As discussed above, the B-side contains at least one base that acts as an acid sensitive chemical blowing agent. Generally, the weak base contains anionic carbonate or hydrogen carbonate, and, as a cation an alkali metal, an alkaline earth metal or a transition metal. Examples of bases suitable for use in the practice of this invention include calcium carbonate, barium carbonate, strontium carbonate, magnesium carbonate, lithium carbonate, sodium carbonate, potassium carbonate, rubidium carbonate, cesium carbonate, calcium hydrogen carbonate, barium hydrogen carbonate, strontium hydrogen carbonate, magnesium hydrogen carbonate, lithium hydrogen carbonate, sodium hydrogen carbonate, potassium hydrogen carbonate, rubidium hydrogen carbonate, cesium hydrogen carbonate, and bicarbonates and combinations thereof. In exemplary embodiments, the base is sodium bicarbonate. The base may be present in an amount from about 1.0 to about 30% by weight of the dry foam composition. In preferred embodiments, the base is present in the B-side in an amount from about 3.0 to about 20% by weight of the dry foamable composition. Sodium bicarbonate and citric acid in a ratio of 7:1 to 4:1 are examples of a base and acid acting as the blowing agent package in at least one exemplary embodiment of the invention.

In addition to the components set forth above, the A-side and/or the B-side may contain one or more surfactants to impart stability to the acrylic during the foaming process, to provide a high surface activity for the nucleation and stabilization of the foam cells, and to modify the surface tension of the latex suspension to obtain a finely distributed, uniform foam with smaller cells. Useful surfactants include cationic, anionic, amphoteric and nonionic surfactants such as, for example, carboxylate soaps such as oleates, ricinoleates, castor oil soaps and rosinates, quaternary ammonium soaps and betaines, amines and proteins, as well as alkyl sulphates, polyether sulphonate (Triton X200K available from Cognis), octylphenol ethoxylate (Triton X705 available from Cognis), octylphenol polyethoxylates (e.g., Triton X110 available from Cognis), alpha olefin sulfonate, sodium lauryl sulfates (e.g., Stanfax 234 and Stanfax 234LCP from Para-Chemicals), ammonium laureth sulfates (e.g., Stanfax 1012 and Stanfax 969(3) from Para-Chemicals), ammonium lauryl ether sulfates (e.g., Stanfax 1045(2) from Para-Chemicals), sodium laureth sulfates (e.g., Stanfax 1022(2) and Stanfax (1023(3) from Para-Chemicals), and sodium sulfosuccinimate (e.g., Stanfax 318 from Para-Chemicals). The surfactant may be present in the A- and/or B-side in an amount from about 0 to about 20% by weight of the dry foam composition.

Further, the A-side and B-side may contain a thickening agent to adjust the viscosity of the foam. It is desirable that the A-side and the B-side have the same or nearly the same viscosity to achieve the desired ratio of the A-side components to the B-side components. This permits for easy application and mixing of the components of the A-side and B-side. Suitable examples of thickening agents for use in the foamable composition include calcium carbonate, methyl cellulose, ethyl cellulose, hydroxyethyl cellulose (e.g., Cellosize® HEC available from Union Carbide), alkaline swellable polyacrylates (e.g., Paragum 500 available from Para-Chem), sodium polyacrylates (e.g., Paragum 104 available from Para-Chem), glass fibers, cellulose fibers, and polyethylene oxide.

In at least one exemplary embodiment, the A-side contains one or more components selected from a non-ionic urethane rheology modifier such as Acrysol™ RM-825, commercially available from Rhom and Haas; Optigel® WX, an activated smectite product; and Laponite® RD clay, a synthetic layered silicate available from Southern Clay Products, Inc. and the B-side contains at least one thickener selected from a mixed diamide thickening agent such as Thixatrol Max® commercially available from Elementis Specialties and Garamite® 1958, a mixed mineral thixotrope available from Southern Clay. The Laponite® products belong to a family of synthetic, layered silicates produced by the Southern Clay Products Corporation.

As described above, it is desirable that the A-side and the B-side have the same or nearly the same viscosity to achieve the desired ratio of the A-side components to the B-side components to permit easy application and mixing of the components of the A-side and B-side. In at least one exemplary embodiment, a 4:1 ratio permits for easy application and mixing of the components of the A-side and B-side. The thickening agents may be present in the A-side and the B-side, respectively, in an amount up to about 50% by weight of the dry foam composition. In at least one exemplary embodiment, the amount of thickening agent present in the A-side is from about 0.1 to about 10.0% by weight, based on the dry foamable composition, and the amount of thickening agent present in the B-side is from about 0.1 to about 10.0% by weight, based on the dry foamable composition, depending upon the nature of the thickening agent.

An additional plasticizer may also be present in the A-side and/or B-side to adjust the viscosity of the foam. Non-limiting examples of suitable plasticizers include phthalate ester, dimethyl adipate, dimethyl phthalate, epoxidized crop oils (e.g., Drapex 10.4, Drapex 4.4, and Drapex 6.8 available from Chemtura). The plasticizer may be present in the foamable composition in an amount from about 0 to about 20% by weight of the dry foam composition. Desirably, the plasticizer is present in an amount from about 0 to about 15% by weight.

Further, an alcohol such as ethanol or isopropanol may be present in the foam composition in the A-side and/or the B-side. The alcohol is preferably miscible with water and has a low boiling point. The alcohol acts as a co-solvent and replaces a portion of the water in the latex serum. Utilizing an alcohol co-solvent allows for a quicker drying/curing time after the foam's application. Additionally, the co-solvent assists in creating a foam with a fine cell structure. Although not wishing to be bound by theory, it is believed that the higher vapor pressure of the alcohol causes the alcohol to be driven off more quickly than the water in the latex solution, and that the alcohol carries the water molecules as the alcohol is removed. The co-solvent is used in small quantities, typically from about 1.0 to about 5.0% by weight of the foam composition.

Depending on the type of particles used in the latex solution, the A- or B-side may also include other optional, additional components such as, for example, foam promoters, opacifiers, accelerators, foam stabilizers, dyes (e.g., diazo or benzimidazolone family of organic dyes), color indicators, gelling agents, flame retardants, biocides, fungicides, algaecides, corrosion inhibitors, fillers (aluminum tri-hydroxide (ATH)), and/or conventional blowing agents. It is to be appreciated that a material will often serve more than one of the aforementioned functions, as may be evident to one skilled in the art, even though the material may be primarily discussed only under one functional heading herein. The additives are desirably chosen and used in a way such that the additives do not interfere with the mixing of the ingredients, the cure of the reactive mixture, the foaming of the composition, or the final properties of the foam.

To form a two-part spray foam of the present invention, the components of the A-side and the components of the B-side are delivered through separate lines into a spray gun, such as an impingement-type spray gun. The two components are pumped through small orifices at high pressure to form streams of the individual components of the A-side and the B-side. The streams of the first and second components intersect and mix with each other within the gun and begin to react. Depending on the components of the blowing agent package in the A-side and the B-side, the gas generated may be CO₂, N₂, O₂, H₂, or other non-carcinogenic gases. For example, the acid and the base may react to form carbon dioxide (CO₂) gas. The foaming reaction occurs until all of the blowing agent(s) have been reacted and no more gas is generated.

In addition, the polyfunctional aziridine crosslinking agent reacts with the acid and with the functional groups on the acrylic to support the foamed structure. Although not wishing to be bound by theory, it is believed that the acid in the A-side reacts with the base in the B-side first and then with the polyfunctional aziridine crosslinking agent. The polyfunctional aziridine also reacts with the functional groups positioned on the latex. The reaction of the polyfunctional aziridine with the acid and the latex to form a polymeric scaffolding-like structure (skeleton) that holds the foam structure while the latex is coagulating and hardening. The previously fluid/viscous foam material is substantially immobilized by the internal scaffolding-structure which prevents the foam from collapsing. It is hypothesized that the use of a polymeric acid advantageously provides for a more flexible backbone in the polymeric structure. It is to be appreciated that the amount of functionality in the polyfunctional aziridine crosslinking agent, the latex, and the acid are adjusted to result in optimum crosslinking.

It is to be appreciated that the crosslinking is important for capturing the bubbles generated by the evolution of the gas in their original, fine structure before they can coalesce and escape the foam. A fine foam structure is more desirable and more beneficial than a coarse foam structure in order to achieve high thermal performance. Additionally, the crosslinking of the functional groups on the functionalized latex quickly builds strength in the foam and permits the foam to withstand the force of gravity when it is placed, for example, in a vertical wall cavity during application. The final foamed product becomes cured to the touch within minutes after application. The foamed product has an integral skin that restricts the passage of air but permits the passage of water vapor. In exemplary foamed products, the foam hardens within about 2 minutes. The resulting resistance to heat transfer, or R-value, may be from about 3.5 to about 8 per inch.

In use, the inventive foams may be sprayed into either an open cavity, such as between wall studs, or into a closed cavity where it expands to seal any open spaces. The application is desirably a continuous spray process. Alternatively, the foams may be applied in a manner to fill or substantially fill a mold or fed into an extruder or an injection molding apparatus, such as for reaction injection molding (RIM), and used to form items such as cushions, mattresses, pillows, and toys. For example, a functionalized water-soluble or functionalized water-dispersible resin (e.g., functionalized latex or functionalized latex and acrylic solution), a crosslinking agent, and a blowing agent may be mixed and applied to a mold where the crosslinking agent reacts with the functionalized resin while the blowing agent degrades or reacts to form a gas and initiate the foaming reaction.

The foams of the present invention may be used to insulate buildings such as homes from temperature fluctuations outside of the building's envelope. The foams may serve both as a conductive and a convective thermal barrier. The foams of the present invention may also serve as a sealant or barrier to air infiltration by filling cracks and/or crevices in a building's roof or walls. Additionally, the foams may be used to form a barrier to seal cracks or crevasses around doors, windows, electric boxes, and the like.

In addition, the foams of the present invention are preferably non-structural foams. The soft foam nature of the functionalized water-soluble and functionalized water-dispersible resins allows for easy compaction. As such, the inventive foams have several benefits. For example, there is no post-application waste to an open wall cavity. If there is an overfilling of the cavity, the drywall simply compresses the foam back into the cavity. The inventive foams are giving, so it will not apply a significant pressure to the drywall and little or no bowing or detachment of the drywall will occur.

Another advantage of the foams of the present invention is the safe installation of the foam into cavities. The foams do not release any harmful vapors into the air when applied or sprayed. Therefore, the inventive foams reduce the threat of harm to individuals working with or located near the foam. In addition, the application of the foams is more amenable to the installer as he/she will not need to wear a special breathing apparatus during installation.

Another advantage of the inventive foams is that it can be used in the renovation market, as well as in houses that are occupied by persons or animals. Existing, conventional spray polyurethane foams cannot be used in these applications because of the generation of high amounts of free isocyanate monomers that could adversely affect the occupants of the dwelling. As discussed above, exposure of isocyanate monomers may cause irritation to the nose, throat, and lungs, difficulty in breathing, skin irritation and/or blistering, and a sensitization of the airways.

Yet another advantage of the present invention is that the toxic components of the polyfunctional aziridine can be diluted with a plasticizer(s) to reduce health risks to those in contact with the polyfunctional aziridine. The acid impurities of the plasticizer react with the toxic ethyleneimine to neutralize it and make the foam safe for those in contact with the foam. In addition, diluting the polyfunctional aziridine crosslinking agent reduces the viscosity of the B-side so that the components of the B-side can be better mixed with the latex of the A-side in the spray gun. Also, the plasticizer in the B-side permits the foam composition to be delivered with standard plural component spray equipment, thereby negating the need for any specialized equipment.

It is further advantageous that the inclusion of the plasticizer in the B-side allows for the inclusion of other solid materials that may add functionality and/or cost savings to the final foamed product. Additionally, the B-side is stable for extended periods of time as long as there are no acidic protons present in the B-side components.

It is also an advantage of the present invention is that the components of the one-part or two-part foam compositions are carefully chosen to result in a tacky or sticky foam that can be used to hold the fiberglass batt in place when used to fill cracks or crevasses.

Having generally described this invention, a further understanding can be obtained by reference to certain specific examples illustrated below which are provided for purposes of illustration only and are not intended to be all inclusive or limiting unless otherwise specified.

### EXAMPLES

### Example 1

The polyfunctional aziridine XAMA®-7 was tested for the presence of ethyleneimine (aziridine) or propyleneimine (methyl aziridine). Samples 1 and 2 were duplicate neat samples of XAMA®-7.

A sample of approximately 200 mg was placed inside a 25 ml headspace vial. The sample vial was equilibrated at 150° C. for 30 minutes. After equilibration, dual needles were inserted into the headspace volume and the entire contents were swept onto a Vocarb 3000™ trap that was maintained at 27° C. After 5 minutes of sweeping the headspace, the trap was thermally desorbed at 270° C. Volatiles from the trap were swept onto a 30 meter fused silica HP-624 capillary column that was attached to a mass selective detector. The column oven was temperature programmed from 35° C. to 240° C. at a rate of 10° C./minute with initial and final column temperature held for 5 minutes. Data was collected on full scan mode. The results are set forth in Table 1.

TABLE 1
Estimation of Aziridine Concentration in the Headspace Vial

| | Sample | Integrated | μg Aziridine in | |
|---|---|---|---|---|
| | Weight | Area | 25 ml Headspace | |
| Sample | (g) | (TIC) | Volume | μg/g |
| Sample 1 | 0.23646 | 525, 742, 251 | 16.0 | 66 |
| Sample 2 | 0.22408 | 520, 639, 335 | 15.8 | 71 |

It was determined that there was no ethyleneimine (aziridine) or propyleneimine (methyl aziridine) present in a sample that contained the B-side components (not indicated in Table 1). In addition, there was no indication that propyleneimine (methyl aziridine) was present in either Sample 1 or Sample 2. There was, however, a high concentration of ethyleneimine (aziridine) in each of the samples of the XAMA®-7. As discussed above, ethyleneimine is a toxic substance. This analysis shows that although an average of approximately 69 μg/g of ethyleneimine (aziridine) is present in the headspace of neat XAMA®-7 at 150° C., the headspace of the B-side components is free of ethyleneimine (aziridine). It is hypothesized that this absence of ethyleneimine (aziridine) in the B-side is partly due to the dilution factor itself partly due to the fact that the ethyleneimine (aziridine) reacts quickly with the acid impurities and small water content of the other components in the B-side.

### Example 2

A sample of a mixture of XAMA®-7 (polyfunctional aziridine) and Benzoflex® 2088 (a benzoate ester plasticizer available from Genovique Specialties) in a ratio of 2:1 was tested to determine if ethyleneimine (aziridine) or propyleneimine (methyl aziridine) was present.

A portion of the sample (approximately 100 mg) was placed inside a 25 ml headspace vial. The sample vial was equilibrated at 80° C. for 15 minutes. After equilibration, dual needles were inserted into the headspace volume and the entire contents were swept onto a Vocarb 3000™ trap that was maintained at 27° C. After 10 minutes of sweeping the headspace, the trap was thermally desorbed at 270° C. Volatiles from the trap were swept onto a 30 meter fused silica HP-624 capillary column that was attached to a mass selective detector. The column was temperature programmed from 35° C. to 240° C. at a rate of 10° C./minute with initial and final column temperature held for 5 minutes. Data was collected in full scan mode. The results are set forth in Table 2.

TABLE 2
Estimation of Aziridine Concentration in the Headspace Vial

| | Sample | μg Aziridine in | |
|---|---|---|---|
| | Weight | 25 ml Headspace | |
| Sample | (g) | Volume | μg/g |
| Benzoflex ® 2088^{a} | 0.306 | <0.01 | <0.03 |

^{a}a benzoate ester plasticizer available from Genovique Specialties

As shown in Table 2, the concentration of ethyleneimine (aziridine) was determined to be less than 0.03 μg/g. It is believed that the concentration of ethyleneimine (aziridine) present in the sample is lowered, partly due to the dilution factor itself and partly due to the fact that the ethyleneimine (aziridine) reacts quickly with the small quantities of acid and water present in the Benzoflex® 2088 as impurities.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A two-part foamable composition for forming a foam comprising:
a first component including at least one functionalized resin selected from a functionalized water-dispersible resin and a functionalized water-soluble resin and an acid; and
a second component including a polyfunctional aziridine crosslinking agent that crosslinks at or about room temperature, a plasticizer, and a base,
wherein said plasticizer has no acidic protons to react with said polyfunctional aziridine crosslinking agent.

2. The two-part foamable composition of claim 1, wherein said plasticizer is selected from a benzoate ester, triethyl citrate, a tributyl citrate, polyethylene glycol, an octylphenoxypolyethoxyethanol, butyl benzoate and combinations thereof.

3. The two-part foamable composition of claim 2, wherein said second component further comprises at least one member selected from coacervating agents, fillers, nucleating agents and foaming agents.

4. The two-part foamable composition of claim 2, wherein said plasticizer is a benzoate ester and said benzoate ester reduces the presence of ethyleneimine in said second component to less than about 0.03 μg/g.

5. The two-part foamable composition of claim 2, wherein said plasticizer reduces the viscosity of the second component such that said second component can be mixed with said first component to form an homogenous mixture.

6. The two-part foamable composition of claim 1, wherein said second component further comprises a non-functionalized resin, said non-functionalized resin being non-reactive with said polyfunctional aziridine crosslinking agent.

7. The two-part foamable composition of claim 1, wherein said at least one functionalized resin comprises one or more members selected from a functionalized latex and an acrylic solution.

8. A foamed product comprising the reaction product of:
a first component including at least one functionalized resin selected from a functionalized water-dispersible resin and a functionalized water-soluble resin and an acid; and
a second component including a polyfunctional aziridine crosslinking agent that crosslinks at or about room temperature, a plasticizer, and a base,
wherein said plasticizer has no acidic protons to react with said polyfunctional aziridine crosslinking agent.

9. The foamed product of claim 8, wherein said plasticizer is selected from a benzoate ester, triethyl citrate, a tributyl citrate, polyethylene glycol, an octylphenoxypolyethoxyethanol, butyl benzoate and combinations thereof.

10. The foamed product of claim 9, wherein said second component further comprises at least one member selected from coacervating agents, fillers, nucleating agents and foaming agents.

11. The foamed product of claim 9, wherein said plasticizer is a benzoate ester and said benzoate ester reduces the presence of ethyleneimine in said second component to less than about 0.03 μg/g.

12. The foamed product of claim 8, wherein said at least one functionalized resin comprises one or more members selected from a functionalized latex and an acrylic solution.

13. The foamed product of claim 8, wherein at least one of said first component and second component further includes an alcohol co-solvent.

14. The foamed product of claim 8, wherein said second component further comprises a non-functionalized resin, said non-functionalized resin being non-reactive with said polyfunctional aziridine crosslinking agent.

15. A method of forming a foam barrier comprising:
delivering a first component including one or more functionalized resins selected from a functionalized water-dispersible resin and a functionalized water-soluble resin through a first delivery line to an application device;
delivering a second component including a polyfunctional aziridine crosslinking agent that crosslinks at or about room temperature, a plasticizer, and a base to said application device, said plasticizer having no acidic protons to react with said polyfunctional aziridine crosslinking agent;
mixing said first and second components within said application device to form a reaction mixture;
permitting said polyfunctional aziridine crosslinking agent, said acid, and said one or more functionalized resins to chemically react while said acid and said base react to form a gas to initiate a foaming reaction and form a foam; and
spraying said foam to a desired location, said desired location being selected from an open cavity, a closed cavity, a crevasse and a crack.

16. The method of claim 15, further comprising a diluting step wherein ethyleneimine contained within said polyfunctional aziridine crosslinking agent reacts with acid impurities and water in said second component to reduce the level of said ethyleneimine in said second component to less than about 0.03 μg/g.

17. The method of claim 15, wherein said plasticizer is selected from a benzoate ester, triethyl citrate, a tributyl citrate, polyethylene glycol, an octylphenoxypolyethoxyethanol, butyl benzoate and combinations thereof.

18. The method of claim 17, wherein said second component further comprises at least one member selected from coacervating agents, fillers, nucleating agents and foaming agents.

19. The method of claim 15, wherein said second component further comprises a non-functionalized resin, said non-functionalized resin being non-reactive with said polyfunctional aziridine crosslinking agent.

20. The method of claim 15, wherein at least one of said first component and second component further includes an alcohol co-solvent.
